(19) United States
(12) Patent Application Publication
(10) Pub. No.: US 2019/0246127 A1
(43) Pub. Date: Aug. 8, 2019

(54) WIRELESS TRANSMISSION METHOD AND DEVICE FOR VITRUAL REALITY, TERMINAL AND HEAD-MOUNTED DISPLAY DEVICE

(71) Applicant: SHANGHAI CHAI MING HUANG INFORMATION TECHNOLOGY CO., LTD., Shanghai (CN)

(72) Inventors: Yukun CHEN, Shanghai (CN); Chaiming HUANG, Shanghai (CN); Wei TIAN, Shanghai (CN); Chenglong YU, Shanghai (CN); Huan XU, Shanghai (CN); Jiulong BAO, Shanghai (CN)

(73) Assignee: SHANGHAI CHAI MING HUANG INFORMATION TECHNOLOGY CO., LTD., Shanghai (CN)

(21) Appl. No.: 15/549,326

(22) PCT Filed: Dec. 30, 2016
(86) PCT No.: PCT/CN2016/113832

§ 371 Date: Aug. 7, 2017

(30) Foreign Application Priority Data
Oct. 21, 2016 (CN) 201610920024.8

(51) Int. Cl. H04N 19/436; H04N 19/174; H04N 19/46; H04N 19/70

(52) U.S. Cl. CPC H04N 19/436; H04N 19/70; H04N 19/46; H04N 19/174

(57) ABSTRACT

A wireless transmission method and device for virtual reality, a terminal and a head-mounted display device are provided. The method includes: dividing each frame of a plurality of images to be transmitted into a plurality of slices of images; encoding slices of images obtained by the division of the plurality of images successively, to obtain a plurality of slices of encoded images; and respectively transmitting, receiving, decompressing and displaying the plurality of slices of encoded images and audio data. Efficiency of wireless transmission in VR scenes may be effectively improved.

### CROSS-REFERENCE TO RELATED APPLICATIONS

This application is the national phase of international Application No. PCT/CN2016/113832, filed on Dec. 30, 2016, which claims the benefit of priority to Chinese Patent Application No. 201610920024.8, filed on Oct. 21, 2016, and entitled “WIRELESS TRANSMISSION METHOD AND DEVICE FOR VIRTUAL REALITY, TERMINAL AND HEAD-MOUNTED DISPLAY DEVICE”, the entire disclosure of which are incorporated herein by reference.

### TECHNICAL FIELD

The present disclosure generally relates to virtual reality technology, and more particularly, to a wireless transmission method and device for virtual reality, a terminal and a head-mounted display device.

### BACKGROUND

At present, a commonly used connection method for a Virtual Reality (VR) device based on Personal Computer (PC) is to connect a head-mounted display to the PC using a High-Definition Multimedia. Interface (HDMI) cable. However, this method has a disadvantage that a range of a user's motion is limited and the user's head may be entangled by the HDMI cable and further injured. To solve this problem, a wireless transmission method having the same low-latency with the HDMI cable is needed.

Among existing wireless transmission methods for VR, a commonly used method includes: setting a receiving module in a VR helmet and a transmitting module in a PC; and the transmitting module transmitting each frame of image through a channel of 60 GHZ, where the receiving module supports display resolution of 1080p and a refresh rate of 120 HZ at most. This method has an advantage of being capable of effectively controlling a display latency, for example, within one frame.

However, the above method still has many shortcomings in practice. For example, a receiving angle of the transmitting module and the receiving module is limited to a certain angle (such as)120°. Once the receiving angle exceeds the angle, frame skip will occur. When the head-mounted display has a relatively long distance from the host, signals will attenuate. Besides, with the above method, signals cannot effectively penetrate obstacles, and a little bit blocking will cause data loss. These shortcomings limit the adoption of the wireless transmission method in VR field. The main reason lies in that an angle and a distance between the VR helmet and the PC cannot be fixed in a certain range as a VR system is usually used in a space of at least 5 m×5 m. In addition, in a scene with more than one players, mutual blocking is inevitable. The shortcoming of incapable of penetrating obstacles also makes the method hardly be used for multi-devices.

### SUMMARY

In embodiments of the present disclosure, efficiency of wireless transmission in a VR scene may be improved.

In an embodiment of the present disclosure, a wireless transmission method for VR is provided, including: dividing each frame of a plurality of images to be transmitted into a plurality of slices of images; encoding slices of images obtained by the division of the plurality of images successively, to obtain a plurality of slices of encoded images; and transmitting the plurality of slices of encoded images and audio data, respectively.

Optionally, transmitting the plurality of slices of encoded images and audio data, respectively may include: transmitting the plurality of slices of encoded images and the audio data, respectively, through a 5 GHZ channel.

Optionally, encoding slices of images obtained by the division of the plurality of images successively may include: adding a header for each of the slices of images, and encoding each of the slices of images with the header, where the header includes a frame number and a slice number.

Optionally, encoding slices of images obtained by the division of the plurality of images successively may include: encoding slices of images obtained by the division of the plurality of images successively according to a predetermined format.

Optionally, the predetermined format may include but not limited to at east one of H.264, H.265 and VP9.

In another embodiment of the present disclosure, a wireless transmission method for VR is provided, including: receiving a plurality of slices of encoded images and audio data; decoding the plurality of slices of encoded images to obtain a plurality of slices of decoded images; and displaying transmitted images based on the plurality of slices of decoded images, and playing the audio data, where the plurality of slices of decoded images are obtained by division of each frame of the transmitted images.

Optionally, receiving a plurality of slices of encoded images and audio data may include: receiving the plurality of slices of encoded images and the audio data through a 5 GHZ channel.

Optionally_{;} decoding the plurality of slices of encoded images may include: decoding after analyzing a header of each of the plurality of slices of encoded images, where the header includes a frame number, a slice number, a timestamp, length of a packet and a check code.

Optionally, decoding the plurality of slices of encoded images may include: decoding the plurality of slices of encoded images according to a predetermined format.

Optionally, the predetermined format may include but not limited to at least one of H.264, H.265 and VP9.

Optionally, the method may further include: following decoding the plurality of slices of encoded images to obtain a plurality of slices of decoded images, performing time warping to the plurality of slices of decoded images.

In an embodiment of the present disclosure, a wireless transmission device for VR is provided, including: a dividing circuitry, configured to divide each frame of a plurality of images to be transmitted into a plurality of slices of images; an encoding circuitry configured to encode slices of images obtained by the division of the plurality of images successively, to obtain a plurality of slices of encoded images; and a transmitting circuitry configured to transmit the plurality of slices of encoded images and audio data, respectively.

Optionally, the transmitting circuitry may be configured to transmit the plurality of slices of encoded images and the audio data, respectively, through a 5 GHZ channel.

Optionally, the encoding circuitry may be configured to add a header for each of the slices of images, and encode each of the slices of images with the header, where the header includes a frame number and a slice number.

Optionally, the encoding circuitry may be configured to encode slices of images obtained by the division of the plurality of images successively according to a predetermined format.

Optionally, the predetermined format may include but not limited to at least one of H.264, H.265 and VP9.

In another embodiment of the present disclosure, a wireless transmission device for VR is provided, including: a receiving circuitry configured to receive a plurality of slices of encoded images and audio data; a decoding circuitry configured to decode the plurality of slices of encoded images to obtain a plurality of slices of decoded images; and a displaying circuitry configured to display transmitted images based on the plurality of slices of decoded images, and play the audio data, where the plurality of slices of decoded images are obtained by division of each frame of the transmitted images.

Optionally, the receiving circuitry may be configured to receive the plurality of slices of encoded images and the audio data through a 5 GHZ channel.

Optionally, the decoding circuitry may be configured to decode after analyzing a header of each of the plurality of slices of encoded images, where the header includes a frame number, a slice number, a timestamp, length of a packet and a check code.

Optionally, the decoding circuitry may be configured to decode the plurality of slices of encoded images according to a predetermined format.

Optionally, the predetermined format may include but not limited to at least one of H.264, H.265 and VP9.

Optionally, the device may further include a processing circuitry which is linked to the decoding circuitry and configured to perform time warping to the plurality of slices of decoded images, after the plurality of slices of encoded images are decoded.

In an embodiment of the present disclosure, a terminal is provided, including the above wireless transmission device for VR.

In an embodiment of the present disclosure, a head-mounted display device is provided, including the above wireless transmission device for VR.

Embodiments of the present disclosure may provide following advantages. In embodiments of the present disclosure, each frame of a plurality of images to be transmitted is divided into a plurality of slices of images, slices of images obtained by the division of the plurality of images are encoded successively, to obtain a plurality of slices of encoded images, and the plurality of slices of encoded images and audio data are transmitted, respectively. From above, each frame to be transmitted is divided into the plurality of slices of images, and slices of images obtained by the division are encoded and transmitted respectively. Compared to encoding and transmitting images in a unit of frame in the existing techniques, embodiments of the present disclosure can support in parallel encoding and transmission of a plurality of slices of images in one frame of image, which may improve efficiency of wireless transmission. Particularly when there are a great number of frames of images to be transmitted, efficiency of wireless transmission may be greatly improved.

Further, the plurality of slices of encoded images and the audio data are transmitted, respectively, through a 5 GHZ channel. Compared to transmitting images through a channel of 60 GHZ in the existing techniques, embodiments of the present disclosure may avoid some drawbacks, such as frame loss, signal attenuation and incapability of penetrating obstacles, and may further improve efficiency of wireless transmission.

### BRIEF DESCRIPTION OF THE DRAWINGS

FIG. 1 schematically illustrates a flow chart of a wireless transmission method for VR according to an embodiment;

FIG. 2 schematically illustrates a flow chart of a wireless transmission method for VR according to an embodiment;

FIG. 3 schematically illustrates a flow chart of a wireless transmission method for VR according to an embodiment;

FIG. 4 schematically illustrates a diagram of a wireless transmission procedure for VR according to an embodiment;

FIG. 5 schematically illustrates a structural diagram of a wireless transmission device for VR according to an embodiment; and

FIG. 6 schematically illustrates a structural diagram of a wireless transmission device for VR according to an embodiment.

### DETAILED DESCRIPTION

As described in the background, existing wireless transmission methods have some disadvantages in practice, such as low transmission efficiency and lots of limitations.

In embodiments of the present disclosure, each frame to be transmitted is divided into the plurality of slices of images, and slices of images obtained by the division are encoded and transmitted respectively. Compared to encoding and transmitting images in a unit of frame in the existing techniques, embodiments of the present disclosure can support in parallel encoding and transmission of a plurality of slices of images in one frame of image, which may improve efficiency of wireless transmission. Particularly when there are a great number of frames of images to be transmitted, the efficiency of wireless transmission may be greatly improved.

In order to clarify the object, characteristic and advantages of embodiments of the present disclosure, embodiments of present disclosure will be described clearly in detail in conjunction with accompanying drawings.

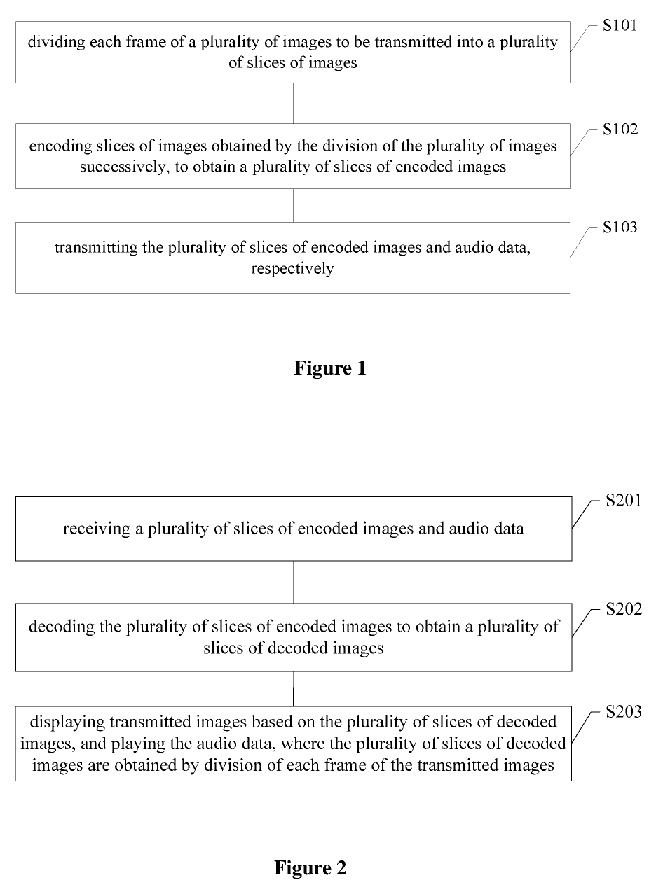

FIG. 1 schematically illustrates a flow chart of a wireless transmission method for VR according to an embodiment.

The method shown in FIG. 1 may be applied for a terminal which includes but not limited to a computer, a notebook computer, a Portable Android. Device (PAD) or a mobile phone. The method may include:

S101, dividing each frame of a plurality of images to be transmitted into a plurality of slices of images;

S102, encoding slices of images obtained by the division of the plurality of images successively, to obtain a plurality of slices of encoded images; and

S103, transmitting the plurality of slices of encoded images and audio data, respectively.

In some embodiments, in a VR scene, a terminal serves as a transmitter and a head-mounted display device serves as a receiver. Data transmitted by the transmitter may be a video including a plurality of frames of images. In the existing techniques, images are transmitted in a unit of frame, while in embodiments of the present disclosure, images are transmitted in a unit of slice. Therefore, in S101, each frame of the plurality of images to be transmitted is divided into a plurality of slices of images. Specifically, each frame of image is divided into a plurality of slices of images, where each slice of image is independent of other slices.

It could be understood that, the number of slices obtained by dividing one frame of image to be transmitted may be adaptively configured according to practical application environment, and is not limited in embodiments of the present disclosure.

In some embodiments, as the transmitter has a great number of data to transmit, to reduce the burden of network and to improve transmission efficiency, in S102, the slices of images obtained in S101 are encoded successively. Specifically, the slices of images obtained by the division of all the images to be transmitted are encoded successively according to a predetermined format. In some embodiments, the predetermined format may include but not limited to at least one of H.264, H.265 and VP9 which are video coding standards. In the existing techniques, data to be transmitted from a transmitter to a receiver is compressed marginally, for example, being converted from a color space format YUV444 to a color space format YUV420. However, in embodiments of the present disclosure, by encoding the slices of images to the predetermined format H.264, H.265 and/or VP9, the data to be transmitted can be divided into smaller data packets, so that the transmission may be more fluent, and it is possible to realize real-time transmission.

In some embodiments, in S103, each frame of image to be transmitted is accompanied with one audio data which cannot be divided into smaller units, thus, each slice of image is transmitted separately from the audio data, to improve transmission efficiency.

In some embodiments, a header with a frame number and a slice number may be added for each of the slices of images before each of the slices of images is encoded. As each frame of image to be transmitted is divided into a plurality of images in S101, before the encoding, a header is added for each slice of image to indicate a position of the slice of image. For example, if the frame number in the header of a slice of image is 1, and the slice number in the header is 2, it indicates that the slice of image is a second slice of image in a first frame of image to be transmitted. In some embodiments, the header may include at least one of a version, a frame number, a slice number, a timestamp, length of a packet and a check code. A format of each slice of image with the added header may be referred to Table 1.

TABLE 1

| | | | | |
|---|---|---|---|---|
| version | frame number | the number of | slice number | length of a |
| | | slices in the frame | | packet |

| | |
|---|---|
| timestamp | check code |

slice payload

As shown in Table 1, each slice of image with the added header may include a slice payload, a frame number, the number of slices in the frame, a slice number, length of a packet, a timestamp and a check code. The slice payload represents effective information carried by the slice of image, the frame number indicates which frame the slice of image is located in, the slice number indicates which slice the slice of image is, the length of the packet represents the length of a data packet where the slice of image in located, the timestamp represents a time point of sampling a first byte of the data packet where the slice of image in located, and the check code may be used for error detection, such as Cyclic Redundancy Check (CRC).

In some embodiments, the plurality of slices of encoded images and the audio data are transmitted, respectively, through a 5 GHZ channel. Compared to transmitting images through a channel of 60 GHZ (i.e., using wireless communication technology of frequency band at about 60 GHz) in the existing techniques, embodiments of the present disclosure divide each frame of image to be transmitted into a plurality of slices of images to take advantages of transmission properties of 5 GHZ. Besides, the plurality of slices of encoded images and the audio data are transmitted through the 5 GHZ channel with the highest transmission rate and the best anti-interference ability. In this way, some drawbacks, such as frame loss, signal attenuation and incapability of penetrating obstacles, may be avoided, transmission efficiency may be improved, and better VR experience may be provided for users.

FIG. 2 schematically illustrates a flow chart of a wireless transmission method for VR according to an embodiment.

The method shown in FIG. 2 may be applied for a head-mounted display device which includes but not limited to a VR helmet or a pair of VR glasses. The method may include:

S201, receiving a plurality of slices of encoded images and audio data;

S202, decoding the plurality of slices of encoded images to obtain a plurality of slices of decoded images; and

S203, displaying transmitted images based on the plurality of slices of decoded images, and playing the audio data, where the plurality of slices of decoded images are obtained by division of each frame of the transmitted images.

It could be understood that, the transmitted images in embodiments for FIG. 2 and the images to be transmitted in embodiments for FIG. 1 are the same ones.

In some embodiments, in a VR scene, a terminal serves as a transmitter and a head-mounted display device serves as a receiver. Data transmitted by the transmitter may be a video including a plurality of frames of images. In the existing techniques, images are transmitted in a unit of frame, while in embodiments of the present disclosure, images are transmitted in a unit of slice. Therefore, in S201, the plurality of slices of encoded images and the audio data are received.

In some embodiments, in S202, the plurality of slices of encoded images are decoded to obtain a plurality of slices of decoded images. Based on the decoding in S202, images to be displayed are acquired. Specifically, a decoder may be used to acquire YUV data corresponding to the plurality of slices of encoded images. In some embodiments, time warping and anti-distortion may be further performed to the YUV data, and the processed YUV data is displayed in S203. in some embodiments, data obtained in S202 is transmitted to a display module and aligned to vertical synchronization (Vsync) display. The Vsync display may make calculation of a graphic card in the head-mounted display device be consistent with a refresh rate of a display on the head-mounted display device, to stabilize display quality and to prevent display tearing when high-speed movement occurs in a scene.

More details of the method in embodiments for FIG. 2 can be found in the description of the method in the above embodiments for FIG. 1, and are not described in detail here.

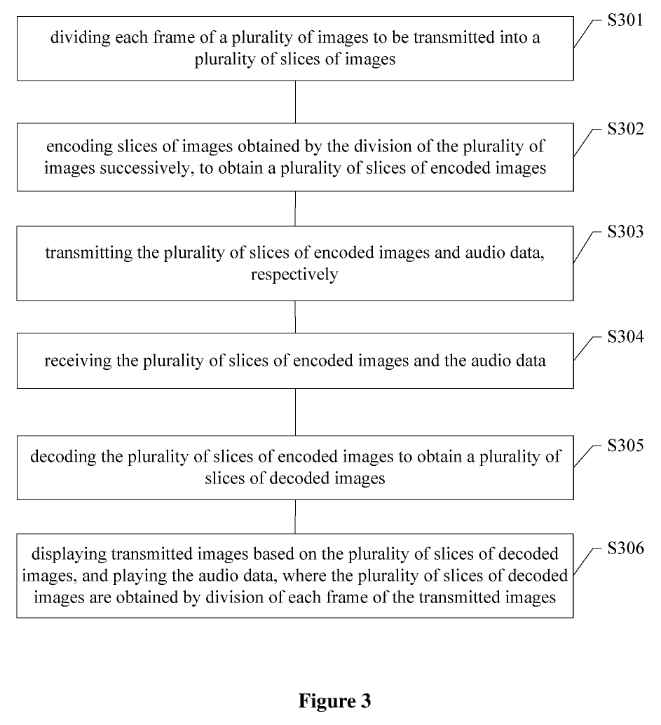

FIG. 3 schematically illustrates a flow chart of a wireless transmission method for VR according to an embodiment.

The method shown in FIG. 3 represents a complete image transmission procedure between a transmitter and a receiver, including:

S301, dividing each frame of a plurality of images to be transmitted into a plurality of slices of images;

S302, encoding slices of images obtained by the division of the plurality of images successively, to obtain a plurality of slices of encoded images;

S303, transmitting the plurality of slices of encoded images and audio data, respectively;

S304, receiving the plurality of slices of encoded images and the audio data;

S305, decoding the plurality of slices of encoded images to obtain a plurality of slices of decoded images; and

S306, displaying transmitted images based on the plurality of slices of decoded images, and playing the audio data, where the plurality of slices of decoded images are obtained by division of each frame of the transmitted images.

In some embodiments, the transmitter may perform S301 to S303, to implement division, encoding and transmission of each frame of image to be transmitted; and the receiver may perform S304 to S306, to implement reception, decoding and display of each frame of transmitted images. It could be understood that, the transmitted images in S306 and the images to be transmitted in S301 are the same ones.

In some embodiments, before displaying the transmitted images and playing the audio data, the transmitted images and the audio data may be mixed to acquire video data to be played.

More details of the method in embodiments for FIG. 3 can be found in the description of the method in the above embodiments for FIGS. 1 and 2, and are not described in detail here.

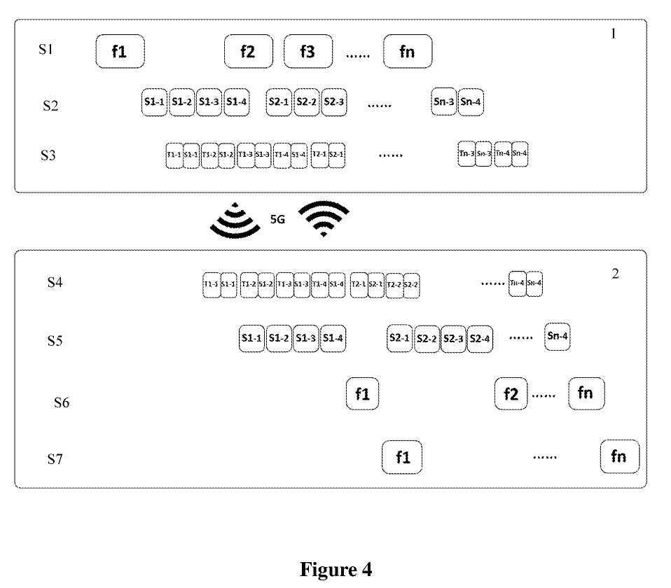

FIG. 4 schematically illustrates a diagram of a wireless transmission procedure for VR according to an embodiment.

The wireless transmission procedure for VR is described in detail in conjunction with FIG. 4 below.

In some embodiments, a Software Development Kit (SDK) module may be integrated in a transmitter 1. Images to be transmitted may be generated by an Application (APP) in the transmitter 1.

In S1, once finishing render of one frame of image to be transmitted, the APP sends the frame of image to the SDK module. Namely, after a frame of image to be transmitted f1 is rendered, the rendered image f1 is sent to the SDK module. Similarly processing is performed to other frames of images to be transmitted f2, f3, . . . , fn. In S2, the SDK module may divide each of the received frames of images to be transmitted into a plurality of slices of images and put the obtained slices of images to an encoder at the transmitter 1. For example, the frame of image f1 is divided into four slices of images including S1-1, S1-2, S1-3 and S1-4. Division results of other frames of images to be transmitted f2, f3, . . . , fn are similar. In S3, a header is added for each slice of image and the slices of images with the header are compressed to a data packet having a predetermined form (H.264, H.265 or VP9) by the encoder, and the encoded slices of images and audio data are transmitted respectively through a 5 GHZ channel. For example, the slice of image S1-1 with the added header is T1-1 S1-1, where the header includes a frame number 1, a slice number 1, a timestamp, length of the data packet and a check code. Header adding results of other slices of images S1-1, S1-3 and S1-4 are similar.

In some embodiments, a SDK module may be also integrated in a head-mounted display device 2. In S4, the SDK module receives data packet T1-1 S1-1, T1-2 S1-2, Tn-4 Sn-4. In S5, the SDK module removes headers in the data packet to obtain slices of images S1-1, S1-2, S1-3, S1-4, Sn-4, and puts the slices of images to a decoder. The decoder performs decoding to obtain corresponding YUV data. That is, after receiving the data packet, the SDK module only needs to perform some analysis to obtain effective payload data corresponding to the slices of images which is then transmitted to the decoder to be decoded. Afterwards, in S6, the SDK module performs time warping and anti-distortion to the YUV data to obtain transmitted images f2, f3, . . . , fn. In some embodiments, when the time warping and anti-distortion is performed according to the timestamp in the header, a display period. and whether compensation is required are determined rapidly. Finally, in S7, the data obtained in S6 is put to a display module and aligned to Vsync display, so that the transmitted images f2, f3, . . . , fn are presented.

In a scene where good VR experience should be provided, there are a great number of data to be transmitted. By employing the wireless transmission methods provided in embodiments of the present disclosure, efficiency of wireless transmission may be improved, which ensures better user experience.

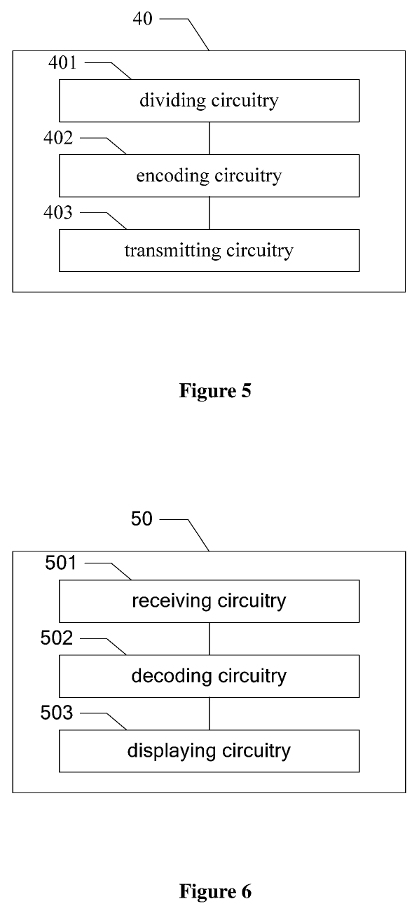

FIG. 5 schematically illustrates a structural diagram of a wireless transmission device for VR according to an embodiment.

The wireless transmission device 40 for VR shown in FIG. 5 may include a dividing circuitry 401, an encoding circuitry 402 and a transmitting circuitry 403.

The dividing circuitry 401 may be configured to divide each frame of a plurality of images to be transmitted into a plurality of slices of images, the encoding circuitry 402 may be configured to encode slices of images obtained by the division of the plurality of images successively, to obtain a plurality of slices of encoded images, and the transmitting circuitry 403 may be configured to transmit the plurality of slices of encoded images and audio data, respectively.

In some embodiments, the transmitting circuitry 403 may be configured to transmit the plurality of slices of encoded images and the audio data, respectively, through a 5 GHZ channel.

In some embodiments, the encoding circuitry 402 may be configured to add a header for each of the slices of images, and encode each of the slices of images with the header, where the header includes a frame number, a slice number, etc.

In some embodiments, the encoding circuitry 402 may be configured to encode slices of images obtained by the division of the plurality of images successively according to a predetermined format. In some embodiments, the predetermined format may include but not limited to at least one of H.264, H.265 and VP9.

More details of the device in embodiments for FIG. 5 can be found in the description of the method in the above embodiments for FIG. 1, and are not described in detail here.

FIG. 6 schematically illustrates a structural diagram of a wireless transmission device for VR according to an embodiment.

The wireless transmission device 50 for VR shown in FIG. 6 may include a receiving circuitry 501, a decoding circuitry 502 and a displaying circuitry 503.

The receiving circuitry 501 may be configured to receive a plurality of slices of encoded images and audio data, the decoding circuitry 502 may be configured to decode the plurality of slices of encoded images to obtain a plurality of slices of decoded images, and the displaying circuitry 503 may be configured to display transmitted images based on the plurality of slices of decoded images, and play the audio data, where the plurality of slices of decoded images are obtained by division of each frame of the transmitted images.

In some embodiments, the receiving circuitry 501 may be configured to receive the plurality of slices of encoded images and the audio data through a 5 GHZ channel.

In some embodiments, the decoding circuitry 502 may be configured to decode after analyzing a header of each of the plurality of slices of encoded images, where the header includes a frame number, a slice number, a timestamp, length of a packet and a check code.

In some embodiments, the decoding circuitry 502 may be configured to decode the plurality of slices of encoded images according to a predetermined format.

In some embodiments, the predetermined format may include but not limited to at least one of H.264, H.265 and VP9.

In some embodiments, the device 50 may further include a processing circuitry (not shown) which is coupled with the decoding circuitry 502 and configured to perform time warping to the plurality of slices of decoded images, after the plurality of slices of encoded images are decoded.

More details of the device in embodiments for FIG. 6 can be found in the description of the method in the above embodiments for FIG. 2, and are not described in detail here.

In an embodiment, a terminals provided. The terminal may include the wireless transmission device 40 for VR (referring to FIG. 5). In some embodiments, the terminal may include but not limited to a computer, a notebook computer, a PAD or a mobile phone.

In an embodiment, a head-mounted display device is provided. The head-mounted display device may include the wireless transmission device 50 for VR (referrining to FIG. 6). In sonic embodiments, the head-mounted display device may include but not limited to a VR helmet or a pair of VR glasses.

Those skilled in the art can understand that all of or a portion of the processes in the method provided in the above embodiments can be implemented by related hardware with instructions of a computer program. The computer program may be stored in a computer readable storage medium, such as a Read-Only Memory (ROM) or a Random Access Memory (RAM) a magnetic disk or an optical disk.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

1. A wireless transmission method for Virtual Reality (VR), comprising:
dividing each frame of a plurality of images to be transmitted into a plurality of slices of images;
encoding slices of images obtained by the division of the plurality of images successively, to obtain a plurality of slices of encoded images; and
transmitting the plurality of slices of encoded images and audio data, respectively.

2. The method according to claim 1, wherein transmitting the plurality of slices of encoded images and audio data, respectively comprises:
transmitting the plurality of slices of encoded images and the audio data, respectively, through a 5GHZ channel.

3. The method according to claim 1, wherein encoding slices of images obtained by the division of the plurality of images successively comprises:
adding a header for each of the slices of images, and encoding each of the slices of images with the header, where the header comprises a frame number and a slice number.

4. The method according to claim 1, wherein encoding slices of images obtained by the division of the plurality of images successively comprises:
encoding slices of images obtained by the division of the plurality of images successively according to a predetermined format.

5. The method according to claim 4, wherein the predetermined format comprises at least one of H.264, H.265 and VP9.

6. A wireless transmission method for Virtual Reality (VR), comprising:
receiving a plurality of slices of encoded images and audio data;
decoding the plurality of slices of encoded images to obtain a plurality of slices of decoded images; and
displaying transmitted images based on the plurality of slices of decoded images, and playing the audio data, where the plurality of slices of decoded images are obtained by division of each frame of the transmitted images.

7. The method according to claim 6, wherein receiving a plurality of slices of encoded images and audio data comprises:
receiving the plurality of slices of encoded images and the audio data through a 5 GHZ channel.

8. The method according to claim 6, wherein decoding the plurality of slices of encoded images comprises:
decoding after analyzing a header of each of the plurality of slices of encoded images, where the header comprises a frame number, a slice number, a timestamp, length of a packet and a check code.

9. The method according to claim 6, wherein decoding the plurality of slices of encoded images comprises:
decoding the plurality of slices of encoded images according to a predetermined format, wherein the predetermined format comprises at least one of H.264, H.265 and VP9.

10. The method according to claim 6, further comprising:
following decoding the plurality of slices of encoded images to obtain a plurality of slices of decoded images, performing time warping to the plurality of slices of decoded images.

11. A wireless transmission device for Virtual Reality (VR), comprising:
a dividing circuitry, configured to divide each frame of a plurality of images to be transmitted into a plurality of slices of images;
an encoding circuitry configured to encode slices of images obtained by the division of the plurality of images successively, to obtain a plurality of slices of encoded images; and
a transmitting circuitry configured to transmit the plurality of slices of encoded images and audio data, respectively.

12. The device according to claim 11, wherein the transmitting circuitry is configured to transmit the plurality of slices of encoded images and the audio data, respectively, through a 5 GHZ channel.

13. The device according to claim 11, wherein the encoding circuitry is configured to add a header for each of the slices of images, and encode each of the slices of images with the header, where the header comprises a frame number and a slice number, and
wherein the encoding circuitry is configured to encode slices of images obtained by the division of the plurality of images successively according to a predetermined format, where the predetermined format comprises at least one of H.264, H.265 and VP9.

14. A wireless transmission device for Virtual Reality (VR), comprising:
a receiving circuitry configured to receive a plurality of slices of encoded images and audio data;
a decoding circuitry configured to decode the plurality of slices of encoded images to obtain a plurality of slices of decoded images; and
a displaying circuitry configured to display transmitted images based on the plurality of slices of decoded images, and play the audio data, where the plurality of slices of decoded images are obtained by division of each frame of the transmitted images.

15. The device according to claim 14, wherein the receiving circuitry is configured to receive the plurality of slices of encoded images and the audio data through a 5 GHZ channel.

16. The device according to claim 14, wherein the decoding circuitry is configured to decode after analyzing a header of each of the plurality of slices of encoded images, where the header comprises a frame number, a slice number, a timestamp, length of a packet and a check code, and
wherein the decoding circuitry is configured to decode the plurality of slices of encoded images according to a predetermined format, where the predetermined format comprises at least one of H.264, H.265 and VP9.

17. The device according to claim 14, further comprising:
a processing circuitry which is coupled with the decoding circuitry and configured to perform time warping to the plurality of slices of decoded images, after the plurality of slices of encoded images are decoded.

18. A terminal, comprising the a wireless transmission device for Virtual Reality (VR), wherein the wireless transmission device for VR comprises:
a dividing circuitry, configured to divide each frame of a plurality of images to be transmitted into a plurality of slices of images;
an encoding circuitry configured to encode slices of images obtained by the division of the plurality of images successively, to obtain a plurality of slices of encoded images; and
a transmitting circuitry configured to transmit the plurality of slices of encoded images and audio data, respectively.

19. A head-mounted display device, comprising a wireless transmission device for Virtual Reality (VR), wherein the wireless transmission device for VR comprises:
a receiving circuitry configured to receive a plurality of slices of encoded images and audio data;
a decoding circuitry configured to decode the plurality of slices of encoded images to obtain a plurality of slices of decoded images; and
a displaying circuitry configured to display transmitted images based on the plurality of slices of decoded images, and play the audio data, where the plurality of slices of decoded images are obtained by division of each frame of the transmitted images.

20. The head-mounted display device according to claim 19, wherein the decoding circuitry is configured to decode after analyzing a header of each of the plurality of slices of encoded images, where the header comprises a frame number, a slice number, a timestamp, length of a packet and a check code, and
wherein the decoding circuitry is configured to decode the plurality of slices of encoded images according to a predetermined format, where the predetermined format comprises at least one of H.264, H.265 and VP9.
